(19) United States
(12) Patent Application Publication
(10) Pub. No.: US 2026/0168911 A1
(43) Pub. Date: Jun. 18, 2026

(54) DEVICE AND METHOD FOR TESTING OMNIDIRECTIONAL ANISOTROPIC PERMEABILITY TENSOR

(71) Applicant: Southwest Petroleum University, Chengdu (CN)

(72) Inventors: Zhenglan Li, Chengdu (CN); Junfu Zhang, Chengdu (CN); Yu Peng, Chengdu (CN); Jinzhou Zhao, Chengdu (CN); Jiangnuo Lu, Chengdu (CN); Taixin Liu, Chengdu (CN)

(21) Appl. No.: 19/342,650

(22) Filed: Sep. 28, 2025

(30) Foreign Application Priority Data
Dec. 16, 2024 (CN) 202411851952.4

(51) Int. Cl. G01N 15/08

(52) U.S. Cl. CPC G01N 15/0826

(57) ABSTRACT

The present application discloses a device and a method for testing an omnidirectional anisotropic permeability tensor, and relates to the technical field of core testing devices. The device includes a core holder and a spherical core, and is provided with a simulated wellbore passing through the spherical core. The spherical core rotates with the simulated wellbore. A flow guide tube and a plurality of liquid flow channels are also provided on the core holder. When in use, the omnidirectional anisotropy measurement for the core permeability can be achieved by rotating the spherical core and changing the liquid flow channels, thereby completing the measurement of the core permeability tensor.

### CROSS-REFERENCE TO RELATED APPLICATIONS

This application claims priority to Chinese Patent Application No. 202411851952.4, filed on Dec. 16, 2024, which is hereby incorporated by reference in its entirety.

### TECHNICAL FIELD

The present application relates to the technical field of core testing devices, specifically to a device and a method for testing an omnidirectional anisotropic permeability tensor.

### BACKGROUND

Since rock particles have directionality during the sedimentation process, anisotropy caused by the pore arrangement of the rock particles is ubiquitous. Permeability anisotropy is a basic characteristic of rock permeability. Almost all rocks have a certain degree of anisotropy with different degrees. This anisotropy has a significant impact on oil and gas flow. During the development and production of oil and gas fields, changes in permeability may cause fluctuations in production capacity. Therefore, accurately measuring the permeability tensor of rocks is of great significance to exploration and development as well as oil well production research.

At present, according to the permeability tensor testing method commonly used at home and abroad, in a mold cavity of a specific shape, a displacement pressure difference is applied to an end face of a cylindrical rock sample, fluid is injected at a constant rate, a pressure drop is measured by a pressure sensor, and a permeability tensor is calculated using Darcy's formula. Currently, there is a significant amount of research on a two-dimensional permeability tensor, with a limited focus on a three-dimensional permeability tensor. However, these traditional testing methods are often limited to permeability testing in a single direction, making it difficult to comprehensively and accurately obtain an anisotropic permeability tensor. Therefore, the development of a device and a method for testing an omnidirectional anisotropic permeability tensor is of great significance.

### SUMMARY

To solve at least one of the foregoing problems, the present application provides a device for testing an omnidirectional anisotropic permeability tensor.

The present application adopts the following technical solution. A device for testing an omnidirectional anisotropic permeability tensor includes:
a spherical core, wherein a rubber sleeve is provided outside the spherical core, and a simulated wellbore wall is provided within the spherical core;
a core holder, wherein the core holder is composed of at least two parts of shells, a pressure chamber is provided inside the core holder, the spherical core is arranged inside the pressure chamber, and a gap is provided between the spherical core and an inner wall of the core holder; the core holder is also provided with a simulated wellbore, one end of the simulated wellbore is provided inside the simulated wellbore wall, the other end of the simulated wellbore is provided outside the core holder, and when the simulated wellbore rotates, the spherical core is driven to rotate; the core holder is further provided with a plurality of liquid flow channels and a confining pressure channel, a flow guide tube is provided in the liquid flow channel, and one end of the flow guide tube is provided inside the rubber sleeve; and
an injection-production system, wherein the injection-production system includes an injection pump, a confining pressure pump and a meter, an output end of the injection pump is connected to a first pressure gauge and the simulated wellbore in sequence, an output end of the confining pressure pump is connected to the confining pressure channel, and the meter is connected to a second pressure gauge and the flow guide tube in sequence.

In an embodiment of the present application, the core holder is composed of two hemispherical shells, and the pressure chamber is spherical.

Further, an annular rotating disk is provided between the two shells, and one end of the simulated wellbore passes through the rotating disk and is provided inside the simulated wellbore wall.

Preferably, the rotating disk is provided with a plurality of positioning blocks, and the shell is provided with annular positioning grooves matching the positioning blocks.

In an embodiment of the present application, a rubber sealing strip is provided between two adjacent shells of the core holder, and the core holder is further provided with at least one clamping band for fastening the shells.

In an embodiment of the present application, a plurality of liquid flow channels are provided on a plurality of parts of the core holder, and any one of the liquid flow channels is provided with a sealing plug.

Another objective of the present application is to disclose a method for testing an omnidirectional anisotropic permeability tensor, which adopts any one of the foregoing devices, and includes the following steps:
S1. cutting a hole in the rubber sleeve, so that the flow guide tube extends into the rubber sleeve, sealing the flow guide tube and the rubber sleeve with a sealant, and installing equipment after the sealing is completed;
S2. applying confining pressure to the pressure chamber using the confining pressure pump, injecting fluid into the spherical core at a constant rate using the injection pump, metering produced fluid from the flow guide tube using the meter, and recording pressure changes at an inlet and an outlet of the spherical core during the experiment using the first pressure gauge and the second pressure gauge, and depressurizing the pressure chamber after the experiment is completed;
S3. removing the core holder and the sealant, sealing the hole on the rubber sleeve, then rotating the simulated wellbore, and repeating the S1 and the S2 until a permeability of the hole within a circumference range is measured;
S4. installing a new liquid flow channel, repeating the S1 to the S3, and completing omnidirectional permeability measurement of the spherical core;
S5. calculating the permeability tensor:

$$K = ( \begin{matrix}{K}_{\text{?}} & {K}_{\text{?}} & {K}_{\text{?}} \\ {K}_{\text{?}} & {K}_{\text{?}} & {K}_{\text{?}} \\ {K}_{\text{?}} & {K}_{\text{?}} & {K}_{\text{?}}\end{matrix} ) ,$$

$$\text{?} \text{indicates text missing or illegible when filed}$$

wherein Kₓₓ, K_{yy} and K_{zz} are three main permeability coefficients on a diagonal line, representing degrees of fluid penetration in x, y and z directions, respectively, and are obtained by measuring the x, y and z directions using a test device; K_{xy}, K_{xz}, K_{yx}, K_{yz}, K_{zx} and K_{zy} represent cross permeability coefficients between different directions; since the permeability tensor is symmetrical, K_{xy}=K_{yx}, K_{xz}=K_{zx}, and K_{yz}=K_{zy};

according to Darcy's law and matrix multiplication, a seepage velocity equation in each direction is obtained; according to the seepage velocity equation, K_{xy}, K_{xz} and K_{yz} are solved and obtained:

$${V}_{x} = - \frac{{K}_{xx}}{μ} \frac{\partial P}{\partial x} - \frac{{K}_{xy}}{μ} \frac{\partial P}{\partial y} - \frac{{K}_{xz}}{μ} \frac{\partial P}{\partial z}$$

$${V}_{y} = - \frac{{K}_{yx}}{μ} \frac{\partial P}{\partial x} - \frac{{K}_{yy}}{μ} \frac{\partial P}{\partial y} - \frac{{K}_{yz}}{μ} \frac{\partial P}{\partial z}$$

$${V}_{z} = - \frac{{K}_{\text{?}}}{μ} \frac{\partial P}{\partial x} - \frac{{K}_{\text{?}}}{μ} \frac{\partial P}{\partial y} - \frac{{K}_{\text{?}}}{μ} \frac{\partial P}{\partial z}$$

$$wherein \frac{\partial P}{\partial x} , \frac{\partial P}{\partial y} and \frac{\partial P}{\partial z}$$

$$\text{?} \text{indicates text missing or illegible when filed}$$

are pressure gradients in the X, Y and Z directions, respectively; under the premise of constant displacement,

$$\frac{\partial P}{\partial x} , \frac{\partial P}{\partial y} and \frac{\partial P}{\partial z}$$

are obtained after the fluid flow rate stabilizes; and μ is a fluid viscosity; Vₓ, V_{y} and V_{z} represent components of the seepage velocity along the X, Y and Z axes, respectively.

Beneficial effects: According to the device for testing the omnidirectional anisotropic permeability tensor provided by the present application, the rock sample needs to be first polished and processed into a spherical core, and then a rubber sleeve is installed. Through the joint action of the core holder and the injection-production system, the measured fluid flow, seepage velocity and permeability on the three main axes are obtained, and finally the permeability tensor of the spherical core is solved using the permeability tensor formula. The device has a simple structure, convenient operation, and strong applicability.

In addition, the present application also provides a corresponding testing method for a device for testing an omnidirectional anisotropic permeability tensor, further making the permeability tensor testing device more practical.

### BRIEF DESCRIPTION OF THE DRAWINGS

FIG. 1 is a schematic diagram of an overall structure of a device in Embodiment 1;

FIG. 2 is a cross-sectional view of a core holder in Embodiment 1 with no rotating disk provided;

FIG. 3 is a cross-sectional view of a core holder in Embodiment 1 with a rotating disk provided; and

FIG. 4 is a schematic structural diagram of a hemispherical shell of a core holder in Embodiment 1 with a rotating disk provided.

Reference numerals: 1. core holder, 101. shell, 2. simulated wellbore, 3. liquid flow channel, 4. first pressure gauge, 5. injection pump, 6. confining pressure pump, 7. meter, 8. clamping band, 9. confining pressure channel, 10. pressure chamber, 11. rubber sleeve, 12. spherical core, 13. simulated wellbore wall, 14. rotating disk, 15. positioning block, 16. sealing plug, 17. flow guide tube, 18. second pressure gauge, 19. rubber sealing strip, and 20. annular positioning groove.

### DESCRIPTION OF EMBODIMENTS

The specific implementations of the present application will be described clearly and completely below with reference to examples and drawings. It is clear that the described embodiments are merely a part rather than all of embodiments of the present application.

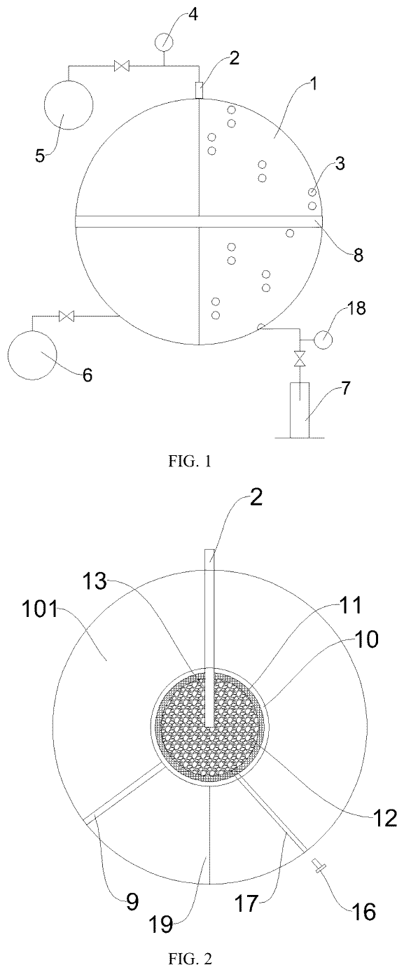

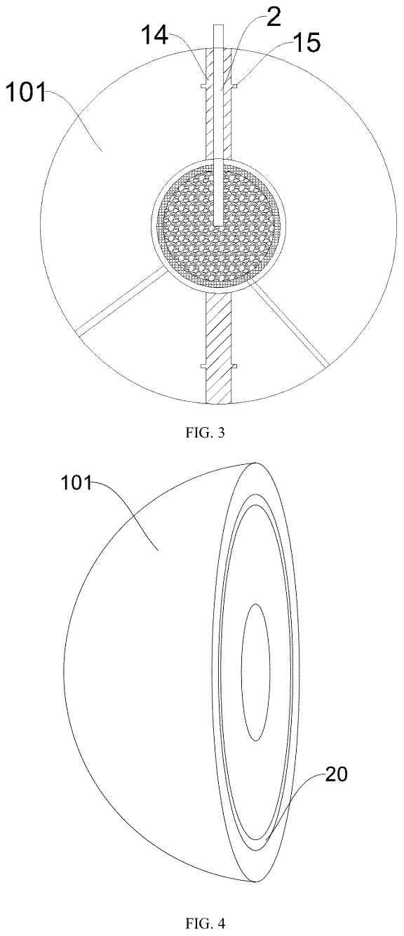

Embodiment 1: As shown in FIGS. 1 to 4, a device for testing an omnidirectional anisotropic permeability tensor includes:
a spherical core 12, wherein a rubber sleeve 11 is provided outside the spherical core 12, and a simulated wellbore wall 13 is provided within the spherical core 12;
a core holder 1, wherein the core holder 1 is composed of at least two parts of shells 101, a pressure chamber 10 is provided inside the core holder 1, the spherical core 12 is arranged inside the pressure chamber 10, and a gap is provided between the spherical core 12 and an inner wall of the core holder 1; the core holder 1 is also provided with a simulated wellbore 2, one end of the simulated wellbore 2 is provided inside the simulated wellbore wall 13, the other end of the simulated wellbore is provided outside the core holder 1, and when the simulated wellbore 2 rotates, the spherical core 12 is driven to rotate; the core holder 1 is further provided with a plurality of liquid flow channels 3 and a confining pressure channel 9, a flow guide tube 17 is provided in the liquid flow channel 3, and one end of the flow guide tube 17 is provided inside the rubber sleeve 11; and
an injection-production system, wherein the injection-production system includes an injection pump 5, a confining pressure pump 6 and a meter 7, an output end of the injection pump 5 is connected to a first pressure gauge 4 and the simulated wellbore 2 in sequence, an output end of the confining pressure pump 6 is connected to the confining pressure channel 9, and the meter 7 is connected to a second pressure gauge 18 and the flow guide tube 17 in sequence.

Specifically, in this embodiment, when the spherical core 12 is manufactured, a rock block with uniform texture and no significant fissures and impurities should be selected, and then cut and polished to a suitable size. Generally, considering the subsequent experimental operations, the size of the spherical core 12 is generally more than ten centimeters to several tens of centimeters. Those skilled in the art can select a spherical core 12 with a suitable size based on actual conditions.

The simulated wellbore wall 13 in the spherical core 12 is usually arranged along a diameter direction of the spherical core 12; specifically, one end of the simulated wellbore wall 13 is arranged at a center of the spherical core 12, and the other end of the simulated wellbore wall 13 is arranged on a surface of the spherical core 12, which is the same as a conventional wellbore wall.

The function of the rubber sleeve 11 is to separate the spherical core 12 from the confining pressure oil in the pressure chamber 10, which is the same as the function of conventional rubber sleeves in the art. Therefore, a rubber sleeve commonly used in the art can be used.

The core holder 1 is composed of at least two parts of shells 101, such as two or three parts. However, considering practical operation, in this embodiment, the core holder is configured as two hemispherical shells 101 with hemispherical grooves therein. When the two hemispherical shells 101 are combined, the two hemispherical grooves form a relatively sealed pressure chamber 10. Of course, those skilled in the art may also use shells and grooves in other shapes, such as square shells and square grooves. However, since it is relatively difficult to calculate the angle of a square shell, those skilled in the art may make a choice based on actual conditions. Meanwhile, it is known to those skilled in the art that, to improve the sealing performance of the core holder 1 composed of two parts of the shells 101, a corresponding rubber sealing strip 19 can be provided between the shells 101, and a clamping band 8 for fastening the shell 101 can be provided outside the shell 101. Of course, those skilled in the art may also use other components that can be used to fasten the shell 101, such as providing corresponding tabs and bolts on the shell 101. Those skilled in the art may select a suitable fastening method based on actual conditions.

An outer diameter of the simulated wellbore 2 is the same as an inner diameter of the simulated wellbore wall 13, and a material with greater friction resistance, such as a rubber layer, is provided on an outer wall of the simulated wellbore 2. When the simulated wellbore 2 rotates, the spherical core 12 can be driven to rotate. Meanwhile, one end of the simulated wellbore 2 needs to pass through the rubber sleeve 11 and be positioned inside the simulated wellbore wall 13. Therefore, during the equipment installation, the connection between the simulated wellbore 2 and the rubber sleeve 11 needs to be sealed with a suitable sealant. The sealant used may be a two-component polysulfide sealing paste. Those skilled in the art may select an appropriate sealant based on actual conditions.

The liquid flow channel 3 is mainly configured to produce the fluid injected into the spherical core 12 by the injection pump 5. Therefore, a flow guide tube 17 is provided inside the liquid flow channel 3. Meanwhile, one end of the flow guide tube 17 is provided inside the rubber sleeve 11. To ensure the sealing performance of the rubber sleeve 11, the following operations are usually required before installing the core holder 1. The cutting and drilling are performed on the rubber sleeve 11, the flow guide tube 17 is inserted into the rubber sleeve 11, the gap between the flow guide tube 17 and the rubber sleeve 11 is sealed with a sealant, the core holder 1 is installed, and one end of the flow guide tube 17 is arranged outside the core holder 1 through the liquid flow channel 3. To prevent liquid leakage from the gap between the flow guide tube 17 and the liquid flow channel 3, the gap needs to be sealed. The sealing method can be implemented in a variety of ways, such as by applying a sealant or providing a corresponding sealing ring. The method is conventional in the art, and specific operations are not detailed here. Similarly, the sealant used in this step may also be a two-component polysulfide sealing paste, or other sealants in the art.

Meanwhile, a plurality of liquid flow channels 3 may be arranged in advance on the shell 101 based on actual conditions, with an intersection of any diameter of the spherical core 12 and the surface of the spherical core 12 as a pole (equivalent to the South Pole and the North Pole of the earth). The intersections of the plurality of liquid flow channels 3 and the spherical core 12 are arranged at different latitudes of the spherical core 12. When even a plurality of liquid flow channels 3 are provided in advance, a sealing plug 16 is provided on each of the liquid flow channels 3, and the liquid flow channel 3 is blocked by the sealing plug 16 when not in use.

In other cases, to test the spherical core 12 from more angles and reduce the number of liquid flow channels 3, an annular rotating disk 14 is provided between the two shells 101, and one end of the simulated wellbore 2 passes through the rotating disk 14 and is arranged inside the simulated wellbore wall 13. An outer diameter of the rotating disk 14 is the same as an outer diameter of the shell 101, and an inner diameter of the rotating disk 14 is the same as a diameter of the pressure chamber 10. Meanwhile, a corresponding through hole is provided on the rotating disk 14, and one end of the simulated wellbore 2 passes through the through hole and is arranged in the simulated wellbore wall 13. In this case, when the rotating disk 14 rotates, even if the position of the liquid flow channel 3 is not changed, the circumference of the spherical core 12 corresponding to the liquid flow channel 3 may be changed, so that the permeability and conductivity of the spherical core are tested from a plurality of angles and directions. Preferably, to facilitate installation of the rotating disk 14, a plurality of positioning blocks 15 are provided on the rotating disk 14, and annular positioning grooves 20 matching the positioning blocks 15 are provided on the shell 101. Therefore, the rotating disk 14 and the shell 101 can be installed using the positioning blocks 15 and the annular positioning grooves 20.

The confining pressure channel 9 is mainly configured to allow the confining pressure oil output by the confining pressure pump 6 to enter the pressure chamber 10 to apply confining pressure to the spherical core 12, which is a conventional configuration.

The injection-production system is a conventional system in the art, and the specific structure of the injection-production system is not detailed here.

Embodiment 2: A method for testing an omnidirectional anisotropic permeability tensor, which adopts the device in Embodiment 1, and includes the following steps:
S1. cutting a hole in the rubber sleeve 11, so that the flow guide tube 17 extends into the rubber sleeve 11, sealing the flow guide tube 17 and the rubber sleeve with a sealant 11, and installing equipment after the sealing is completed;
S2. applying confining pressure to the pressure chamber 10 using the confining pressure pump 6, injecting fluid into the spherical core 12 at a constant rate using the injection pump 5, metering produced fluid from the flow guide tube 17 using the meter 7, and recording pressure changes at an inlet and an outlet of the spherical core during the experiment using the first pressure gauge 4 and the second pressure gauge 18, and depressurizing the pressure chamber 10 after the experiment is completed;
S3. removing the core holder 1 and the sealant, sealing the hole on the rubber sleeve 11, then rotating the simulated wellbore 2, and repeating the S1 and the S2 until a permeability of the hole within a circumference range is measured; wherein in this process, the hole on the rubber sleeve 11 can be sealed with a currently commonly used rubber sealant, such as an acrylic sealing paste, and those skilled in the art can also use other sealants;
S4. installing a new liquid flow channel 3, repeating the S1 to the S3, and completing omnidirectional permeability measurement of the spherical core;
S5. calculating the permeability tensor:

$$K = ( \begin{matrix}{K}_{\text{?}} & {K}_{\text{?}} & {K}_{\text{?}} \\ {K}_{\text{?}} & {K}_{\text{?}} & {K}_{\text{?}} \\ {K}_{\text{?}} & {K}_{\text{?}} & {K}_{\text{?}}\end{matrix} ) ,$$

$$\text{?} \text{indicates text missing or illegible when filed}$$

wherein Kₓₓ, K_{yy} and K_{zz} are three main permeability coefficients on a diagonal line, representing degrees of fluid penetration in x, y and z directions, respectively, and are obtained by measuring the x, y and z directions using a test device; K_{xy}, K_{xz}, K_{yx}, K_{yz}, K_{zx} and K_{zy} represent cross permeability coefficients between different directions; since the permeability tensor is symmetrical, K_{xy} K_{yx}, K_{xz}=K_{zx}, and K_{yz}=K_{zy},
according to Darcy's law and matrix multiplication, a seepage velocity equation in each direction is obtained; according to the seepage velocity equation, K_{xy}, K_{xz} and K_{yz} are solved and obtained:

$${V}_{x} = - \frac{{K}_{xx}}{μ} \frac{\partial P}{\partial x} - \frac{{K}_{xy}}{μ} \frac{\partial P}{\partial y} - \frac{{K}_{xz}}{μ} \frac{\partial P}{\partial z}$$

$${V}_{y} = - \frac{{K}_{yx}}{μ} \frac{\partial P}{\partial x} - \frac{{K}_{yy}}{μ} \frac{\partial P}{\partial y} - \frac{{K}_{yz}}{μ} \frac{\partial P}{\partial z}$$

$${V}_{z} = - \frac{{K}_{\text{?}}}{μ} \frac{\partial P}{\partial x} - \frac{{K}_{\text{?}}}{μ} \frac{\partial P}{\partial y} - \frac{{K}_{\text{?}}}{μ} \frac{\partial P}{\partial z}$$

$$wherein \frac{\partial P}{\partial x} , \frac{\partial P}{\partial y} and \frac{\partial P}{\partial z}$$

$$\text{?} \text{indicates text missing or illegible when filed}$$

are pressure gradients in the X, Y and Z directions, respectively; under the premise of constant displacement,

$$\frac{\partial P}{\partial x} , \frac{\partial P}{\partial y} and \frac{\partial P}{\partial z}$$

are obtained after the fluid flow rate stabilizes, and the obtaining method is common knowledge in the art; and μ is a fluid viscosity; Vₓ, V_{y} and V_{z} represent components of the seepage velocity along the X, Y and Z axes, respectively, and can be obtained under the premise of constant pressure displacement, and the solving method is common knowledge in the art.

The above descriptions are only preferred embodiments of the present application, and are not intended to limit the present application in any form. Although the preferred embodiments above have disclosed the present application, they are not intended to limit the present application. Any of those familiar with the technical field, without departing from the scope of the technical solutions of the present application, can use the technical content disclosed above to make various changes and modify the technical content as equivalent changes of the equivalent embodiments. However, any simple modifications, equivalent changes and modifications made to the above embodiments according to the technical spirit of the present application without departing from the content of the technical solutions of the present application shall fall within the scope of the technical solutions of the present application.

What is claimed is:

1. A device for testing an omnidirectional anisotropic permeability tensor, comprising:
a spherical core, wherein a rubber sleeve is provided outside the spherical core, and a simulated wellbore wall is provided within the spherical core;
a core holder, wherein the core holder is composed of at least two parts of shells, a pressure chamber is provided inside the core holder, the spherical core is arranged inside the pressure chamber, and a gap is provided between the spherical core and an inner wall of the core holder; the core holder is also provided with a simulated wellbore, one end of the simulated wellbore is provided inside the simulated wellbore wall, the other end of the simulated wellbore is provided outside the core holder, and when the simulated wellbore rotates, the spherical core is driven to rotate; the core holder is further provided with a plurality of liquid flow channels and a confining pressure channel, a flow guide tube is provided in the liquid flow channel, and one end of the flow guide tube is provided inside the rubber sleeve; and
an injection-production system, wherein the injection-production system comprises an injection pump, a confining pressure pump and a meter, an output end of the injection pump is connected to a first pressure gauge and the simulated wellbore in sequence, an output end of the confining pressure pump is connected to the confining pressure channel, and the meter is connected to a second pressure gauge and the flow guide tube in sequence.

2. The device according to claim 1, wherein the core holder is composed of two hemispherical shells, and the pressure chamber is spherical.

3. The device according to claim 2, wherein an annular rotating disk is provided between the two shells, and one end of the simulated wellbore passes through the rotating disk and is provided inside the simulated wellbore wall.

4. The device according to claim 3, wherein the rotating disk is provided with a plurality of positioning blocks, and the shell is provided with annular positioning grooves matching the positioning blocks.

5. The device according to claim 1, wherein a rubber sealing strip is provided between two adjacent shells of the core holder, and the core holder is further provided with at least one clamping band for fastening the shells.

6. The device according to claim 1, wherein a plurality of liquid flow channels are provided on a plurality of parts of the core holder, and any one of the liquid flow channels is provided with a sealing plug.

7. A method for testing an omnidirectional anisotropic permeability tensor, adopting the device according to claim 1, and comprising the following steps:
S1. cutting a hole in the rubber sleeve, so that the flow guide tube extends into the rubber sleeve, sealing the flow guide tube and the rubber sleeve with a sealant, and installing equipment after the sealing is completed;
S2. applying confining pressure to the pressure chamber using the confining pressure pump, injecting fluid into the spherical core at a constant rate using the injection pump, metering produced fluid from the flow guide tube using the meter, and recording pressure changes at an inlet and an outlet of the spherical core during the experiment using the first pressure gauge and the second pressure gauge, and depressurizing the pressure chamber after the experiment is completed;
S3. removing the core holder and the sealant, sealing the hole on the rubber sleeve, then rotating the simulated wellbore, and repeating the S1 and the S2 until a permeability of the hole within a circumference range is measured;
S4. installing a new liquid flow channel, repeating the S1 to the S3, and completing omnidirectional permeability measurement of the spherical core;
S5. calculating the permeability tensor:
$$K = ( \begin{matrix}{K}_{\text{?}} & {K}_{\text{?}} & {K}_{\text{?}} \\ {K}_{\text{?}} & {K}_{\text{?}} & {K}_{\text{?}} \\ {K}_{\text{?}} & {K}_{\text{?}} & {K}_{\text{?}}\end{matrix} ) ,$$
$$\text{?} \text{indicates text missing or illegible when filed}$$
wherein Kₓₓ, K_{yy} and K_{zz} are three main permeability coefficients on a diagonal line, representing degrees of fluid penetration in x, y and z directions, respectively; K_{xy}, K_{xz}, K_{yx}, K_{yz}, K_{zx} and K_{zy} represent cross permeability coefficients between different directions; since the permeability tensor is symmetrical, K_{xy}=K_{yx}, K_{xz}=K_{zx}, and K_{yz}=K_{zy};
according to Darcy's law and matrix multiplication, a seepage velocity equation in each direction is obtained; according to the seepage velocity equation, K_{xy}, K_{xz} and K_{yz} are solved and obtained:
$${V}_{x} = - \frac{{K}_{xx}}{μ} \frac{\partial P}{\partial x} - \frac{{K}_{xy}}{μ} \frac{\partial P}{\partial y} - \frac{{K}_{xz}}{μ} \frac{\partial P}{\partial z}$$
$${V}_{y} = - \frac{{K}_{yx}}{μ} \frac{\partial P}{\partial x} - \frac{{K}_{yy}}{μ} \frac{\partial P}{\partial y} - \frac{{K}_{yz}}{μ} \frac{\partial P}{\partial z}$$
$${V}_{z} = - \frac{{K}_{\text{?}}}{μ} \frac{\partial P}{\partial x} - \frac{{K}_{\text{?}}}{μ} \frac{\partial P}{\partial y} - \frac{{K}_{\text{?}}}{μ} \frac{\partial P}{\partial z}$$
$$wherein \frac{\partial P}{\partial x} , \frac{\partial P}{\partial y} and \frac{\partial P}{\partial z}$$
$$\text{?} \text{indicates text missing or illegible when filed}$$
are pressure gradients in the X, Y and Z directions, respectively; under the premise of constant displacement,
$$\frac{\partial P}{\partial x} , \frac{\partial P}{\partial y} and \frac{\partial P}{\partial z}$$
are obtained after the fluid flow rate stabilizes; and μ is a fluid viscosity; Vₓ, V_{y} and V_{z} represent components of the seepage velocity along the X, Y and Z axes, respectively.
